(19) United States
(12) Patent Application Publication
(10) Pub. No.: US 2022/0055927 A1
(43) Pub. Date: Feb. 24, 2022

(54) DESALINATION OF WATER USING A COMPLEXING AGENT ATTACHED TO A MAGNETIC NANOPARTICLE

(71) Applicants: Vladimir Kogan, Rehovot (IL); Yaron Virtzer, Ramat Hasahron (IL); Lev Ari Remez, Herzelia (IL); Shiri Carmielli, Ness Ziona (IL)

(72) Inventors: Vladimir Kogan, Rehovot (IL); Yaron Virtzer, Ramat Hasahron (IL); Lev Ari Remez, Herzelia (IL); Shiri Carmielli, Ness Ziona (IL)

(21) Appl. No.: 17/001,754

(22) Filed: Aug. 25, 2020

(30) Foreign Application Priority Data
Aug. 24, 2020 (IL) 276904

(51) Int. Cl. C02F 1/68; B03C 1/015; C02F 1/48; B01J 39/17; B01J 45/00

(52) U.S. Cl. CPC C02F 1/683; B03C 1/015; C02F 2103/08; B01J 39/17; B01J 45/00; C02F 1/481

(57) ABSTRACT

There is disclosed, a desalination apparatus making use of a particles including covalently bonded functionalized magnetic nanoparticles coupled to a complexing agent. For example, the complexing agent may include a crown ether. The particles are optionally used for removing salt from water, for example sea water. The apparatus optionally includes a magnet for magnetic filtering, concentrating and/or removing the particles and/or contaminant (e.g. salt). In some embodiments, the salt is then separated back from the particles using UV light. The remaining unclarified water may be washed out with the contaminant and/or used for salt production and/or disposed of (e.g. dumped back to the sea). Optionally, the particles are regenerated. For example, the regenerated particulars may be reused for further desalination steps (e.g. further salt removal from the clarified water) to clarify new input water.

### FIELD AND BACKGROUND OF THE INVENTION

The present invention, in some embodiments thereof, relates to desalination of seawater and, more particularly, but not exclusively, to removing salt from water without removing other minerals and/or without membrane filtration.

U.S. Pat. No. 6,972,095 appears to disclose “A decontamination system uses magnetic molecules having ferritin cores to selectively remove target contaminant ions from a solution. The magnetic molecules are based upon a ferritin protein structure and have a very small magnetic ferritin core and a selective ion exchange function attached to its surface. Various types of ion exchange functions can be attached to the magnetic molecules, each of which is designed to remove a specific contaminant such as radioactive ions. The ion exchange functions allow the magnetic molecules to selectively absorb the contaminant ions from a solution while being inert to other non-target ions. The magnetic properties of the magnetic molecule allow the magnetic molecules and the absorbed contaminant ions to be removed from solution by magnetic filtration.”

U.S. Pat. No. 8,097,164 appears to disclose “A process for selectively removing contaminant ions from a solution includes: a) contacting the solution with magnetic particles coupled to selectively chelating ion exchange functionality containing moieties prepared by: i) activating carboxyl groups on the selectively chelating ion exchange functionality containing moieties by the formation of an acyl fluoride, and ii) reacting the acyl fluoride with the magnetic particles, the magnetic particles having a particle size of less than 10 microns; b) allowing the chelating functionality coupled magnetic particles to selectively bind one or more of the contaminant ions; and, c) extracting the chelating functionality coupled magnetic particles and contaminant ions from the solution by magnetic filtration.”

U.S. Pat. No. 8,636,906 appears to disclose “magnetic nanoparticles and methods of using magnetic nanoparticles for selectively removing biologics, small molecules, analytes, ions, or other molecules of interest from liquids.”

International Patent Application no. 2018104958 appears to disclose “nanoparticle based desalination system and a method of desalination thereof. The subject matter provides a nanoparticle system having a core and a positively charged species coated on the core. The positively charged species has an ionizable group. The pH value of the nanoparticle system is more than the pKa value of the ionizable group and the nanoparticle system is configured to cause desalination of negatively charged ions from an effluent.”

Spanish patent no. 2598032 appears to disclose “Desalination method of brines. Extract the common salt contained in sea water, brackish water from wells or places where the excess of sodium, lithium or potassium chloride contained in the water affects the viability of industrial processes and/or domestic consumption or for the use of salts for industrial purposes. When working with seawater, the priority would be to obtain quality water for industrial use, which can be used as ingest water or for agricultural use. The patent proposal is to use zero-valent iron nanoparticles, alone or in combination with cobalt or manganese nanoparticles, to extract sodium, lithium or potassium chloride from seawater or other waters rich in alkali halides using static magnetic fields.”

Additional art may include studies showing negative health effects that may be associated with conventionally desalinated water and/or lack of minerals such as Magnesium in water.

Additional art may include:
Koren, Gideon & Shlezinger, Meital & Katz, Rachel & Shalev, Varda & Yona, Amitai. (2016). Seawater desalination and serum magnesium concentrations in Israel. Journal of Water and Health. 15:10.2166/wh.2016.164. https://www.researchgate.net/publication/311527623_Seawater_desalination_and_serum_magnesium_concentrations_in_Israel
Koren, Gideon & Yona, Amitai & Shlezinger, Meital & Katz, Rachel & Shalev, Varda. (2018). Sea water desalination and removal of iodine; effect on thyroid function. Journal of Water and Health. 16. wh2018372. 10.2166/wh.2018.372: https://www.researchgate.net/publication/324385621_Sea_water_desalination_and_removal_of_iodine_effect_on_thyroid_function
Shlezinger, Meital & Yona, Amitai & Akriv, Amichay & Gabay, Hagit & Shechter, Michael & Leventer-Roberts, Maya. (2018). Association between exposure to desalinated sea water and ischemic heart disease, diabetes mellitus and colorectal cancer; A population-based study in Israel. Environmental Research. 166. 10.1016/j.envres.2018.06.053: https://www.researchgate.net/publication/326190272 Association between exposure to desalinated sea water and ischemic heart disease diabetes mellitus and colorectal cancer A population-based study in Israel
Shlezinger, Meital & Yona, Amitai & Goldenberg, Ilan & Atar, Shaul & Shechter, Michael. (2019). Acute myocardial infarction severity, complications, and mortality associated with lack of magnesium intake through consumption of desalinated seawater. Magnesium research. 32. 10.1684/mrh.2019.0449: https://www.researchgate.net/publication/336104555 Acute myocardial infarction severity complications and mortality associated with lack of magnesium intake through consumption of desalinated seawater

### SUMMARY OF THE INVENTION

According to an aspect of some embodiments of the invention, there is provided a system for purifying water including: complexing units including each of the complexing units including a complexing site configured to bind a contaminant a reactor configured for mixing water containing the contaminant with the complexing units a concentrator configured for drawing the complexing units to a release area the release area selected from inside of the reactor and in communication with the reactor;

an energy source configured to direct energy to the release area causing the complexing sites release a portion of the contaminant.

According to some embodiments of the invention, the complexing unit is connected to a nano particle by a covalent bond.

According to some embodiments of the invention, the nanoparticle is magnet.

According to some embodiments of the invention, the concentrator includes a magnet.

According to some embodiments of the invention, the magnet includes an electro magnet.

According to some embodiments of the invention, the magnet includes a permanent magnet.

According to some embodiments of the invention, the magnet is movable between a location near the release site for concentrating the particles and a location far from the release site for freeing the particles.

According to some embodiments of the invention, the energy source is configured to direct light to the release area.

According to some embodiments of the invention, the energy source is configured to direct UV light to the release area.

According to some embodiments of the invention, the energy source includes at least one of a source of ultra violet light and a means to direct sunlight to the release area.

According to some embodiments of the invention, the contaminant is salt and the complexing site is configured to bind a component of the salt.

According to some embodiments of the invention, the system is configured for carrying by a person.

According to some embodiments of the invention, the system is packaged in a container for delivery by standard shipping.

According to some embodiments of the invention, the system is built onto a ship.

According to an aspect of some embodiments of the invention, there is provided a complexing unit for use in purifying water including: at least two complexing sites a joint connecting the at least two complexing sites, the joint having a release mode and a collecting mode wherein the in the collecting mode, the at least two complexing sites are far apart and can each complex a contaminant ion and in the release mode the at least two complexing sites are close together such that repulsion between like ions prevents at least a portion of the complexing sites from complexing the contaminant.

According to some embodiments of the invention, each at least two complexing sites includes a crown ether.

According to some embodiments of the invention, the joint includes a diazo moiety.

According to some embodiments of the invention, the complexing unit further includes: a magnetic portion for magnetic filtering of the complexing unit.

According to some embodiments of the invention, the complexing unit further includes: a nanoparticle attached to the complexing unit via a covalent bond.

According to some embodiments of the invention, the nanoparticle is magnetic. According to some embodiments of the invention, the complexing sites are configured to complex to a sodium ion.

According to some embodiments of the invention, the contaminant includes salt.

According to some embodiments of the invention, the joint is configured to change the mode by exposure to an energy.

According to some embodiments of the invention, the energy includes light.

According to some embodiments of the invention, the energy includes UV light.

According to some embodiments of the invention, the energy includes sunlight. According to some embodiments of the invention, the complexing unit where the complexing unit is selective and does not significantly complex any of Magnesium, Calcium and Potassium.

According to an aspect of some embodiments of the invention, there is provided a method of water purification including: mixing a plurality of complexing units with water containing a contaminant; binding the contaminant with the complexing units; concentrating the complexing units bound to the contaminant to a impound area; outputting clean water from a portion of the reactor isolated from the impound zone; releasing the contaminant from the complexing units into a reduced water volume thereby producing concentrated contaminant; collecting the concentrated contaminant.

According to some embodiments of the invention, the releasing includes exposing the complexing units to radiation.

According to some embodiments of the invention, the exposing includes exposing the complexing unit to at least one of UV light, white light and sunlight.

According to some embodiments of the invention, the radiation includes ultraviolet light.

According to some embodiments of the invention, the concentrating includes exposing the complexing units to a magnetic field.

According to some embodiments of the invention, the collecting includes drawing the complexing units to an impound area with a magnet.

According to some embodiments of the invention, the collecting includes activating the magnet.

According to some embodiments of the invention, the contaminant includes salt.

According to some embodiments of the invention, the complexing agent includes a crown ether.

According to some embodiments of the invention, the complexing unit includes a joint connecting the at least two complexing units, the joint having a release mode and a collecting mode wherein the in the collecting mode, the at least two complexing units are far apart and can each complex a contaminant ion and in the release mode the at least two complexing units are close together such that repulsion between like ions prevents at least a portion of the complexing units from complexing the contaminant.

According to some embodiments of the invention, the method where the complexing units are selective and do not significantly complex any of Magnesium, Calcium and Potassium such that the method does not deplete the concentration of Magnesium, Calcium and Potassium.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A is a block diagram of a water desalination system in accordance with an embodiment of the current invention;

FIG. 1B is a block diagram of a water desalination system with an active particle return in accordance with an embodiment of the current invention;

FIG. 2A is a flow chart illustration of a method of water desalination in accordance with an embodiment of the current invention;

FIG. 2B is a flow chart illustration of a method of water desalination with active particle recovery in accordance with an embodiment of the current invention;

FIG. 3 is a schematic view of a photo responsive diazo-crown ether unit switching between in a catching configuration and a releasing configuration in accordance with an embodiment of the current invention;

FIG. 4A is a schematic view of crown ethers far from one to another in a catching configuration holding two cations in accordance with an embodiment of the current invention;

FIG. 4B is a schematic view of crown ethers close one to another in a releasing configuration wherein electrostatic repulsion releases a portion of caught ions in accordance with an embodiment of the current invention;

FIG. 5 is a schematic view of a complexing agent with an Alkyne-modified bis benzocrown disattached from a magnetic nanoparticle in accordance with an embodiment of the current invention;

FIG. 6 is a schematic view of an Alkyne-modified bis benzocrown attached at a condition of Alkyne-Azide Huisgen bipolar 1.3-cycloaddition to a magnetic nanoparticle in accordance with an embodiment of the current invention;

FIG. 7: is a schematic illustration of a scalable desalination system in accordance with an embodiment of the current invention;

FIG. 8 is a schematic illustration of a scalable desalination system with active particle return in accordance with an embodiment of the current invention;

FIG. 9 is a schematic illustration of a scalable desalination system in accordance with an embodiment of the current invention;

FIG. 10 is a schematic illustration of a scalable desalination system with active particle return in accordance with an embodiment of the current invention;

FIG. 11A is an image of a backpack water purification system in accordance with an embodiment of the current invention;

FIG. 11B is schematic illustration of a backpack water purification system in accordance with an embodiment of the current invention;

FIG. 12 is schematic illustration of a vehicle transportable water purification system in accordance with an embodiment of the current invention;

FIG. 13 is schematic illustration of a ship transportable water purification system in accordance with an embodiment of the current invention.

### DESCRIPTION OF SPECIFIC EMBODIMENTS OF THE INVENTION

The present invention, in some embodiments thereof, relates to desalination of seawater and, more particularly, but not exclusively, to removing salt from water without removing other minerals and/or without membrane filtration.

The present invention remove salt from water without heat.

The present invention remove salt from water with low energy/electricity requirements which estimated to be reduce by ˜95%, thereby making desalinated water more affordable for most crop irrigation. The cost estimation is based on the fact that the separation is conducted by applied magnetic field gradients from a permanent rare earth magnet, and hence does not require huge electricity consumption demand by the high pressure feed pumps currently used in desalination process to operate the process at 40-80 bars.

### Overview

UNESCO estimates that around 2.2 billion people live without access to safe, clean drinking water. By 2050, up to 5.7 billion people could be living in areas where water is scarce for at least one month a year. With seawater making up 97.5% of the world's water resource, low energy desalination solutions will be a vital component of providing sufficient levels of good-quality drinking water for a growing population.

The invention in some embodiments thereof relates generally to the method for purifying water, and more particularly an apparatus and method for water desalination (salt removal). Desalination refers to any of several processes that remove salt and other minerals from water. Water is desalinated for example, to convert it to potable fresh water and/or for industrial use and/or for agricultural use.

Many methods of desalination are available. For example, reverse osmosis (RO) or distillation systems for large scale water purification. Many of these methods are characterized by high energy demand. RO systems often require both high pressure produced by pumps and/or extensive maintenance due to fouling and damage to membrane. Thus, in many applications, distillation and/or RO are problematic, for example, for use in places in which energy is limited, such as third world countries and/or rapid deployment such as after hurricane storms or earthquakes. The present invention, in some embodiments thereof, is directed to overcoming or at least reducing the effects of one or more of the problems set forth above.

An aspect of some embodiments of the current invention relates to a desalination apparatus making use of a particles including covalently bonded functionalized magnetic nanoparticles coupled to a complexing agent. For example, the complexing agent may include a crown ether. The particles are optionally used for removing salt from water, for example sea water. The apparatus optionally includes a magnet for magnetic filtering, concentrating and/or removing the particles. Optionally, after the particles are filtered and/or concentrated the clarified water is drained for use. In some embodiments, the salt is then separated back from the particles, for example, using UV light, white light and/or sunlight. The salt may then be washed out, for example with the remaining water. For example, between 85 to 100% of the water may be clarified and/or 60 to 85% of the water may be clarified and/or 30 to 60% of the water may be clarified. The remaining unclarified water may be washed out with the salt and/or used for salt production and/or disposed of (e.g. dumped back to the sea) and/or transferred with the regenerated particles for further clarification. Optionally the regenerated particulars can then be reused for further desalination steps (e.g. further salt removal from the clarified water) and/or to clarify new input water.

Additionally or alternatively, a desalination system may include a pump, a sonication system and/or a heating system. In some embodiments, the invention may include removing salt from water. For example, salt may be removed from flowing water. For example, the system may remove the majority of salt out from the water source like seawater, lake and/or brackish ground water and/or brine.

In some embodiments, the energy and/or electricity requirements may be reduced by between 75 to 99% and/or 50 to 75% and/or 25 to 50% and/or 5 to 25% in comparison to RO. In some embodiments, this will make desalinated water affordable for crop irrigation. In some embodiments, separation is conducted by applied magnetic field gradients, for example from a permanent rare earth magnet. Such separation may not require huge electricity consumption demand by the high pressure feed pumps currently used in desalination process.

An aspect of some embodiments of the current invention relates to a unit (for example a nanoparticle) configured for removing the salt from water. Optionally, the unit includes a magnetic nanoparticle coupled to an ion catching unit. The unit in some embodiments thereof may be regenerated and reused. In a preferred embodiment, salt (e.g. a sodium cation and/or a chloride ion) is trapped by the catching unit (for example the catching unit may include a crown ether). Optionally, a strong magnetic field attracts and/or repels the units. For example, a properly applied field may pull the units over to the sidewalls of a water tank leaving behind purified water. The units are optionally washed away and/or collected for further use. Alternatively or additionally, a valve may direct water from one end of the water tank to the other end allowing for continuous processing. Additionally or alternatively, the system may comprise a power supply for activating a strong magnetic field for concentrating the magnetic units, for example near the bottom of a water tank to allow quick and/or easy separation of the purified water from the concentrated units.

An aspect of some embodiments of the current invention relates to regeneration of particles. Optionally, the ion catching unit may include multiple complexing agents connect to a form changing bond. For example, under a first condition (e.g. dark) the bond holds the complexing agents far apart allowing each complexing agent to catch an ion. Optionally, when exposed to another condition (e.g. light) the bond changes shape bringing the complexing agents close together causing release of a portion of the ions. For example, the complexing agent may include a crown ether group. For example, the bond may include a Diazo moiety. For example, the functionalized nanoparticles are reuse by removing and/or releasing bound salts from the particles using a UV light source and/or a white light source and/or another energy source. Alternatively or additionally, the system may include a one or more mirrors, prisms and/or lenses to direct sunlight as a source of light for release. In some embodiments, the process is scalable. For example, by the application of linearly scalable continuous stirred tank reactors with water flow under gravitation or by single tank or pipes process. For multiple use, the invention, in some embodiments thereof, provides a method of removing the salt from the trapping unit.

Some embodiments, of the present invention may provide various advantages or benefits. For example, the present invention, may facilitate construction and/or maintenance of a desalination system at almost any place on Earth and not only in specific geographical locations that are typically close to power plant and/or near sea shore (for cooling the power plant). Some embodiments of the current invention require less space that conventional desalination plants and/or may be used in areas of less expensive land than conventional desalination plants. In some embodiments, a desalination plant may produce less noise than plants of conventional technologies. For example, reverse osmosis plants may use pumps to achieve high pressures to push water across a semipermeable membrane and/or against an osmotic gradient; pumps may create significant noise. In some embodiments of the current invention, may employ fewer pumps and/or pump water at lower pressures and/or pump less volume and/or reduce noise. The above features of some embodiments of the current invention may facilitate positioning a desalination plant nearby to a city. For example, placing a desalination plant near a city, may save 10's or 100's of kilometers of pipe lines, pumps and maintenance needed to transport water from the desalination plant to the city.

Some embodiments of the present invention are small-size relative to conventional desalination plants, and/or have a small and/or smaller carbon footprint. Optionally, construction and installation are easier, faster, less expensive, and/or has less environmental impact than convention desalination plants. Some embodiments, of the present invention are scalable and/or may be implemented at small mid and/or a large scale, and/or may solve or mitigate the problem of depletion of non-renewable energy sources.

Some embodiments of the present invention may be environmentally friendly. Optionally, the system is based on a closed-loop. For, example there may be reduced and/or no chemical pollution and/or polluting aspects compared to conventional desalination plants. Optionally, the system will reduce the carbon footprint of the power plant compared to conventional desalination plants. Some embodiments may be deployed virtually anywhere and are not limited to only regions with power plant and/or near the sea (for cooling).

Some embodiments of the present invention may require a small and/or reduced land footprint when compared to conventional desalination plants. Alternatively or additionally, a plant in accordance with some embodiments of the current invention may be more economical to construct, to operate and/or to maintain, relative to conventional desalination plants. Some embodiments of the present invention may be installed underground.

Some embodiments of the current invention save resources on pumping of salt water; for example, a conventional desalination plant typically needs powerful and expensive pumps, which are also expensive to operate and to maintain.

Some embodiments of the present invention will not require a particular geographical location and/or access to a power plant. For example, they may be implemented and constructed in any area near urban areas and cities (and thus avoiding and/or reducing and/or minimizing the cost to distribute the water from the desalination plant to consumers), which can save tens to hundreds of kilometers of water pipes and/or pumps and/or power and/or maintenance. For example, a desalination plant according to some embodiments of the current invention may be positioned in or next to highly-populated areas, away from (or without access to) a sea-shore or other body of water. The salt can be used for other purpose like salt for industry and consumers etc.

In some embodiments, a desalination system of the current invention removes salt and/or other contaminants selectively while leaving behind beneficial minerals. For example, conventional desalination methodologies (e.g. membrane filtration, distillation) often remove Magnesium Calcium and Potassium. The removal of Magnesium from drinking water may have a negative health effect on people who depend on the desalinated water for drinking (e.g. ischemic heart disease, diabetes mellitus and/or colorectal cancer). In some embodiments of the current invention, salt is removed from water while Magnesium are substantially unaffected and/or mostly unaffected and/or are left with a desired concentration. Alternatively or additionally, Magnesium and/or other minerals may be selectively removed, retained and/or concentrated and/or collected according for instance with intended use of the water. Water including the proper quantities of minerals (e.g. Calcium, Magnesium, Boron and/or Potassium) may be advantageous for agriculture. An aspect of some embodiments of the current invention includes selectively removing some contaminants (e.g. salt) while selectively retaining and/or adjusting quantities of other minerals in quantities that make the water more suitable for agriculture.

In some embodiments, a system in accordance with the current invention may be less vulnerable to disruption than conventional systems (e.g. membrane filtration and/or distillation). For example, in disaster situations, power supplies may be disrupted. Energy intensive water supply technologies may be disrupted. Such disruption of water supply may compound the disaster. In some embodiments, the current invention allows water purification and/or desalination with reduced power consumption and/or reduced vulnerability to disruption. Alternatively or additionally, some embodiments of the current invention may facilitate transportable water purification and/or desalination systems (for example by ship and/or in containers) that can be transported to a disaster and/or drought stricken area to alleviate short term water supply disruption.

In some embodiments of the current invention, desalination of water is achieved with reduced cost in terms of chemicals, environmental impact and/or labor. For example, conventional desalination methodologies (e.g. membrane filtration) may require chemically intensive and/or labor intensive cleaning (for example of membranes). For example, this cleaning may result in a need to dispose of acidic cleaning waste that may result in significant environmental damage. Furthermore, some conventional desalination techniques (e.g. membrane filtration) may require expensive upkeep (for example of filtration membranes). Some embodiments of the current invention achieve desalination with reduced cleaning, upkeep, and/or environmental impact.

An aspect of some embodiments of the present invention is related to the field of improve population health due to the effect of a magnetic field on water. For example, when applied to water the magnetic field may restructure the water molecules into very small water molecule clusters.

In some embodiments, a system may include a small number of nanoparticles. For example, to achieve high levels of contaminant removal the system may recycle and/or repeated the purification process multiple times to further purify the water of contaminant (e.g. salt).

In some embodiments, a system may include a large number of nanoparticles. For example, the system may achieve high levels of contaminant removal of contaminant (e.g. salt) in a single cycle.

### Specific Embodiments

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

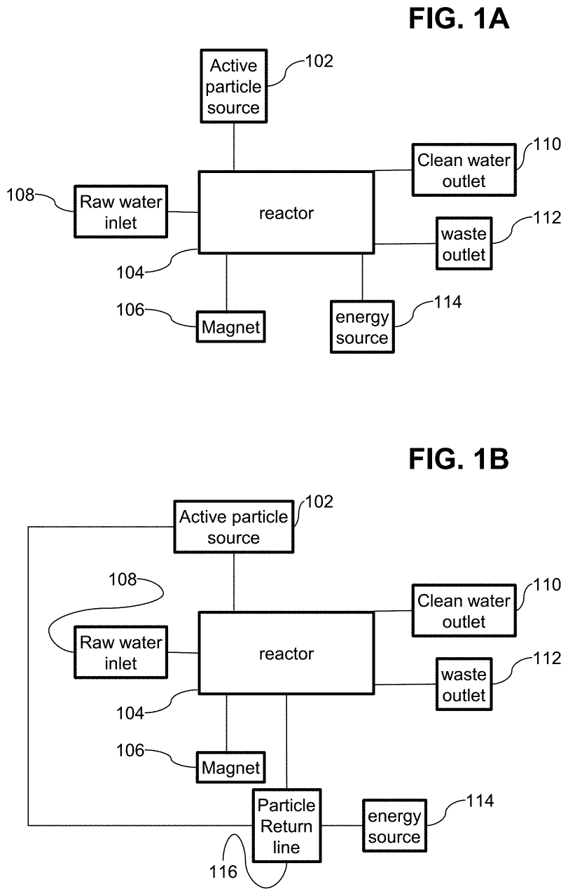

FIG. 1A is a block diagram of a water purification and/or desalination system in accordance with an embodiment of the current invention. FIG. 1B is a block diagram of a water purification and/or desalination system with an active particle return in accordance with an embodiment of the current invention. In some embodiments, raw water having a contaminant, for example salt, enters an inlet 108 and/or is mixed in a reactor 104 with activated particles 102. The particles 102 optionally include a complexing agent for the contaminant and/or a magnetic portion. Optionally, particles are designed to release the contaminant on exposure to an energy, for example the energy may include light (e.g. visible and/or InfraRed IR and/or Ultraviolet UV and/or white light and/or sunlight) or an energy of another form (e.g. radio wave, microwave and/or heat). Optionally, the system includes a magnet 106 and/or an energy source 114 (e.g. a source of energy that causes release of the contaminant from the complexing agent). Optionally, the system includes a clean water outlet 110 and/or a waste outlet 112. In some embodiments, the system may include an active particle return line 116.

In some embodiments, magnet 106 includes a rare earth magnet and/or an electro-magnet which may be connected to a power source to provide the magnetic field. Alternatively or additionally, magnet 106 may include a superconducting electromagnet. Optionally, the magnet 106 may be configured for filtering magnetic particles from fluid in reaction 102. For example, magnet 106 may be positioned near a particle impound area in reactor 104 such that when magnet 106 is deactivated, the particles 102 are free to mix throughout fluid in the reactor 104 and/or when the magnet 106 is activated, the particles are drawn to the impound area. For example, the impound area may be near a wall of the reactor 104 and/or a bottom of the reactor 104. In some embodiments the impound area may be associated with the waste outlet 112 and/or a particle return line 116 and/or may be configured for isolation from the rest of the reactor (e.g. by means of a valve and/or a moving wall etc.). Optionally, a clean water outlet 110 is connected to the reactor at a location that is not in the impound area and/or is far from the impound area. For example, the impound area may include a space near the floor of the reactor 104 and/or the magnet 106 may be positioned below the floor of the reactor and/or the waste outlet 112 may be located near or in the floor of the reactor 104 and/or the clean water outlet 110 may be located higher up in the reactor. Optionally the magnet 106 is activated by directing power to the magnet 106 (e.g. an electromagnet) and/or by moving the magnet 106 towards the impound area and/or towards the reactor (e.g. for a rare earth magnet). Optionally the magnet 106 is deactivated by cutting power to the magnet 106 (e.g. an electromagnet) and/or by moving the magnet 106 away from the impound area and/or away from the reactor (e.g. for a rare earth magnet).

In some embodiments, a system for water purification and/or desalination may be connected to a power supply and/or include a controller. For example, the system may include a dedicated power supply (e.g. a battery and/or a generator) and/or may be connected to a power grid and/or an external power supply. Optionally, a controller may control valves, pumps and/or other components of the system. Optionally, the controller may monitor the system. For example, the controller may receive status information from flow sensors and/or volume sensors and/or concentration sensors (for example electrical conductivity sensors) and/or other temperature sensors and/or pressure sensors and/or other sensors. Optionally, the controller may coordinate actions of the system and/or detect malfunction and/or improve performance (for example repeating cycles of purification to achieve a desired output quality and/or improve efficiency.

In some embodiments an energy source 114 may direct energy toward the impound area of the reactor 104 and/or toward the particle return line 116. For example, the energy may cause the particles to release all or some of the complexed contaminant (e.g. salt).

Optionally, the raw water source for the system may include seawater and/or brackish water and/or brine. In some embodiments, the water treatment process includes source-contaminated water that may be pretreated. Optionally, the system includes a pretreatment module. For example, pretreatment may include ultra-filtration and/or micro-filtration to remove large molecules. For example, pretreatment may include biological material. In some embodiments, the water is held in a mixing water tank including a mixer.

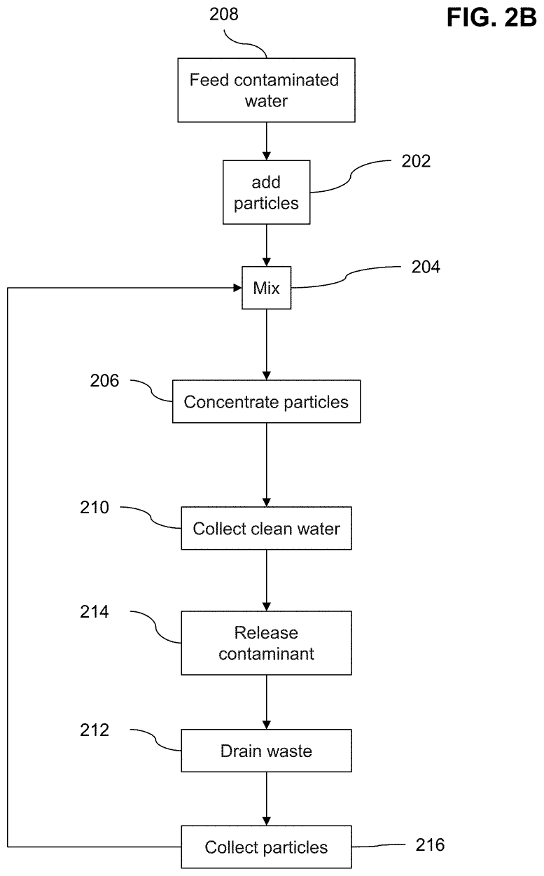

In some embodiments, the system may include a controller, actuators and/or sensors, for example as described above with respect to FIG. 3A.

2A is a flow chart illustration of a method of water desalination in accordance with an embodiment of the current invention.

In some embodiments, reactor is supplied 208 with contaminant isolating units (for example magnetic complexing particles for example as described in FIGS. 3 to 6). Optionally the reactor is filled 202 with raw water (e.g. contaminated water for example where the contaminant is salt). The raw water and isolating units are optionally mixed 204 and/or allowed to react, for example, until the isolating units complex to a significant portion of the contaminant. Optionally, the complexed portion of the contaminant and/or the particles are then concentrated 206 (e.g. in an impound area) and/or separated from the clean water, for example, by activating a magnet to draw the particles with the contaminant to an impound area of the reactor. Optionally clean water is then outputted 210 from the rest of the reactor. In some embodiments the clean water may be outputted 210 for use. Alternatively or additionally, the outputted 210 water may be put through the reactor again as raw water for a further purification. For example, after a few purifications, which are optionally controlled according to suitable sensors, for example, a salinity sensor and/or a conductivity sensor, the water may be ready for use. Optionally, the contaminant is released 214 from the isolation units after the clean water has been outputted 210 from the reactor. For example, an energy source may radiate energy on the remaining isolation units and/or cause them to release 214 all or a part of the contaminant. For example, UV light may be directed to the isolating units causing them to release 214 contaminants. After this stage the remaining concentrated contaminated water is optionally drained 212 out (e.g. via gravitation and/or a pump and/or a valve) while the particles isolating units are retained 213 in the reactor (e.g. by magnetic forces). Optionally, new raw water (and/or the partially purified output water) is fed 202 into the reactor and/or the isolation units are released to mix 204 into the input water. For example, a magnet may be deactivated and/or moved away from the reactor to release the particles.

The concentration 206 step optionally involves the use of an external magnetic field to segregate the magnetic nanoparticles some or all of which are complexed with bound target from the remaining portion of the liquid. For example, the particles may be concentrated in an impound area (which may also be a release area) of the reactor. The extraction may be a batch or continuous process. The external magnetic field may be formed by any type of magnet having a sufficient field force. Strong rare earth magnets that do not use electricity and/or electromagnets provide a magnetic field that attracts the nanoparticles to the as specified location depending of the specific process and apparatus configuration. In some embodiments, the impound area may include the bottom of the liquid receptacle containing the liquid to be purified. The magnetic field may be generated by one or more external magnets to generate a magnetic field flux is between suitable sensor 100 to 1000 Gauss and/or between 1000 to 100000 Gauss and/or between 100,000 to 300,000 Gauss and/or between 300,000 Gauss to 1000000 Gauss, preferably between about 100 Gauss and about 60,000 gauss, most preferably between about 5,000 Gauss and about 30,000 Gauss are used.

In some embodiments, the some of the mechanisms in the system may have secondary benefits. For example, the process of releasing contaminant may involve irradiating the water with UV radiation which may also disinfect the water (for example by killing bacteria and/or deactivating virus). For example, the concentration of the particles with magnets may also remove iron from the water.

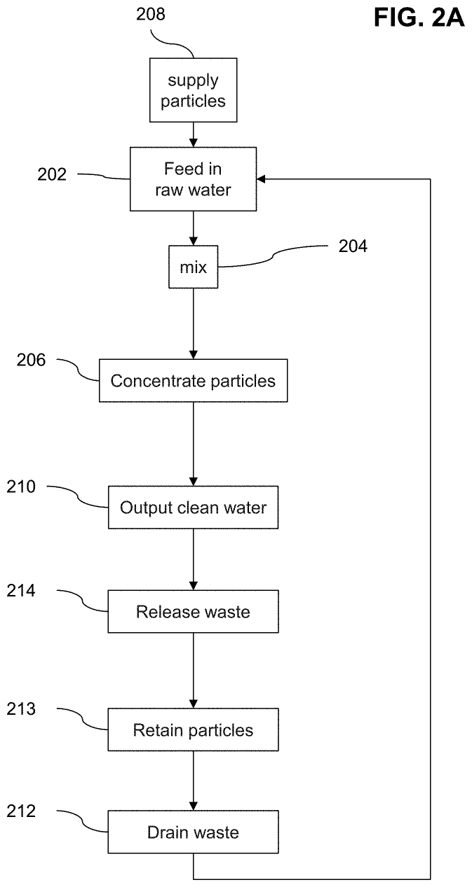

FIG. 2B is a flow chart illustration of a method of water desalination with active particle recovery in accordance with an embodiment of the current invention. Optionally, the step of releasing 214 contaminant from the isolation units may be performed in a separate reactor from the main reactor where the isolation units are mixed 204 with the raw water. This may be advantageous in cases where the conditions and/or geometry of the main reactor are not conducive to the release process and/or when the release process takes a significant amount of time. Additionally or alternatively, there may be an additional step of collecting 216 the regenerated isolation units after they have released 214 a portion of the contaminant and/or returning them to the main reactor.

In some embodiment, the recovered nanoparticles may be added to the clean water and/or desalination may be repeated multiple times on the same water to further purify the water of salt. For example, repeated application of particles may be used when there are only a small number of particles. Alternatively or additionally, it may take only one time to further purify the water of salt, for example, when there is a large quantity of nanoparticles.

The nanoparticles are optionally regenerated and/or are reusable. In a typical one tank batch embodiment, the liquid is held in a mixing tank fitted with a stirrer. The stirrer can be a continuous stirrer, non-continuous stirrer, a magnetic stirrer, or other mixing apparatus that achieves proper mixing of the liquid and nanoparticles.

Functionalized or unfunctionalized nanoparticles are mixed with the contaminated water, for example, from 1 sec to 500 min, preferably between about 10 sec to about 200 min, most preferably between about 1 min to about 60 minutes with the aid of the mixing apparatus.

FIG. 3 is a schematic view of a photo responsive diazo-crown ether unit switching between in a catching configuration 336 and a releasing configuration 338 in accordance with an embodiment of the current invention.

The following explanation is supplied to give a possible rational explanation to a possible theoretical model underlying the invention, but without limiting the invention to a particular theoretical model. Optionally, in dark conditions, a joint, for example including a diazo moiety 332, connects to two crown ethers 334 distanced apart in a catching configuration 336. For example, in the catching configuration 336, the crown ethers 334 may be connected to the diazo moiety 332 in the trans configuration. Optionally, in the catching configuration, each crown ether is free to complex the target (e.g. an ion). Upon exposure to light at a particular frequency and/or power, the unit switches 335 from the catching configuration 336 to the releasing cis configuration 338. For example, the crowns 334 are brought close to one another. For example, when exposed to ultra violet (UV) light, the crown ethers 334 connected by the Diazo moiety 334 in the cis configuration. Optionally, when the ethers 334 are brought together, a portion of the complexed ions may be released for example due to repulsive forces between the cations. For example, about half the cations may be released.

In some embodiments, a crown ether 334 may be based on benzo-15-5 crowns and/or benzo-18-6 crowns that may be symmetrical or non-symmetrical. Alternatively or additionally, a crown ether 334 may be based on Bis benzo-15-5-crowns, bis benzo-18-6-crowns and mixed benzo-15-5-crown-benzo-18-6 crown. Any or all of the above crowns and/or any combination thereof may be connected via a diazo moiety 332. Alternatively or additionally, a different moiety may be used to connect two or more complexing agents and/or ion trapping moieties. In some embodiments, covalent bonds between functionalized magnetic nanoparticles and functionalized crown ether may be formed via azide, amine, carboxylic acid, alcohol, phenol and other on the magnetic side, and alkyne, carboxylic acid, amine and other on the crown side. Connection of the magnetic nanoparticle to the complexing agent bin include a triazole,amide,ester, a substituted amide, various covalent bonds and many other connections.

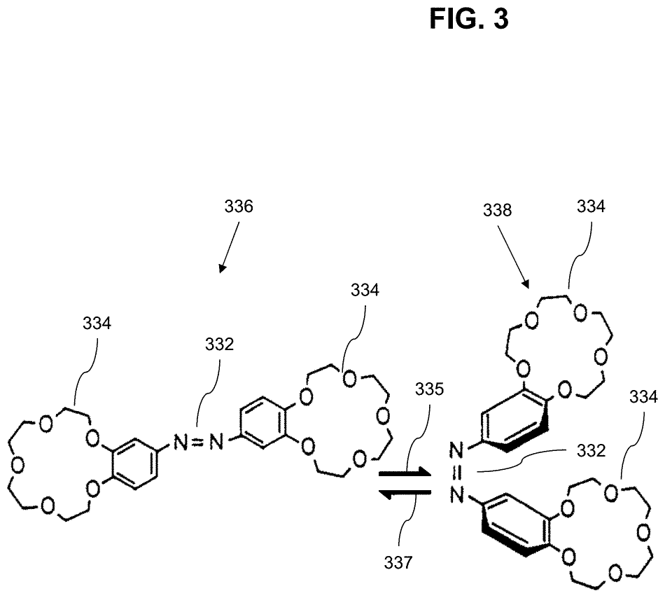

FIG. 4A is a schematic view of crown ethers 334 in a far from one to another in a catching configuration 436 holding two cations 440 in accordance with an embodiment of the current invention. FIG. 4B is a schematic view of crown ethers 334 close one to another in a releasing configuration 438 wherein electrostatic repulsion releases a portion of caught ions 440 in accordance with an embodiment of the current invention. For example, when the crown ethers 334 are distanced one from the other, each crown ether 334 may trap a similar ion (e.g. a cation 340 (e.g. Na+) and/or anion (e.g. CO); but when the crown ethers 334 are brought close to one another, the similarly charged ions 340 may repel each other causing, for example, about half of the ions 340 to be released back into solution. For example, the catching process may be in the trans mode, when complexing agents (for example crown ethers 334) catch each one ion. A release process occurs, for example, under UV and/or visible light and/or white light and/or sunlight the complexing agents move close one to another and electrostatic repulsion release half of the ions.

In some embodiments, complexing agents include molecules and/or moieties that able form coordinative bonds with ions. For example, crown ether type moieties may complex alkali metals cations. Crown ethers 334 may include, for example, heterocyclic chemical compounds that consist of a ring containing several ether groups. Common crown ethers include oligomers of ethylene oxide, the repeating unit being ethyleneoxy, i.e., —CH2CH2O—. Important members of this series include the tetramer (n=4), the pentamer (n=5), and the hexamer (n=6). Benzo-crown ethers include heterocyclic chemical compounds that fused to benzene ring. Benzyl and Phenyl Aza-Crowns include moieties where Benzylic and Phenylic groups attached to one or more Nitrogens of the crown.

The term “Crown” refers to the resemblance between the structure of a crown ether bound to a cation, and a crown sitting on a head. The first number in a crown ether's name refers to the number of atoms in the cycle, and the second number refers to the number of those atoms that are oxygen. Although the term crown ether has specific meaning it is applied herein to a much broader collection of molecules than just the oligomers of ethylene oxide such as the nitrogen containing ligands known as cryptands as well as mixed oxygen-nitrogen compounds, e.g., aza-crowns.

In some embodiments, crown ethers strongly bind certain cations, forming complexes. In some embodiments, a crown ether may have high selectivity to particular ions based on ring size. Optionally, the oxygen atoms coordinate with a cation located at the center of the ring, whereas the exterior of the ring is hydrophobic. A characteristic of a crown ether of some embodiments of the current invention is the complexation of the ether oxygens (or Nitrogens) with various ionic species. For example, once a charged ionic species is bound, the crown compound is then termed “host-guest” chemistry. The crown ether may act as the “host” taking ionic species as its “guest.” In some embodiments, the Crown compound locks guest atoms in a solution and wrap around it. The size of the polyether influences the affinity of the crown ether for various cations. For example, some 18-crown-6 ethers have a high affinity for a potassium cation, some 15-crown-5 ethers have affinity for sodium cations, and some 12-crown-4 ethers have affinity for lithium.

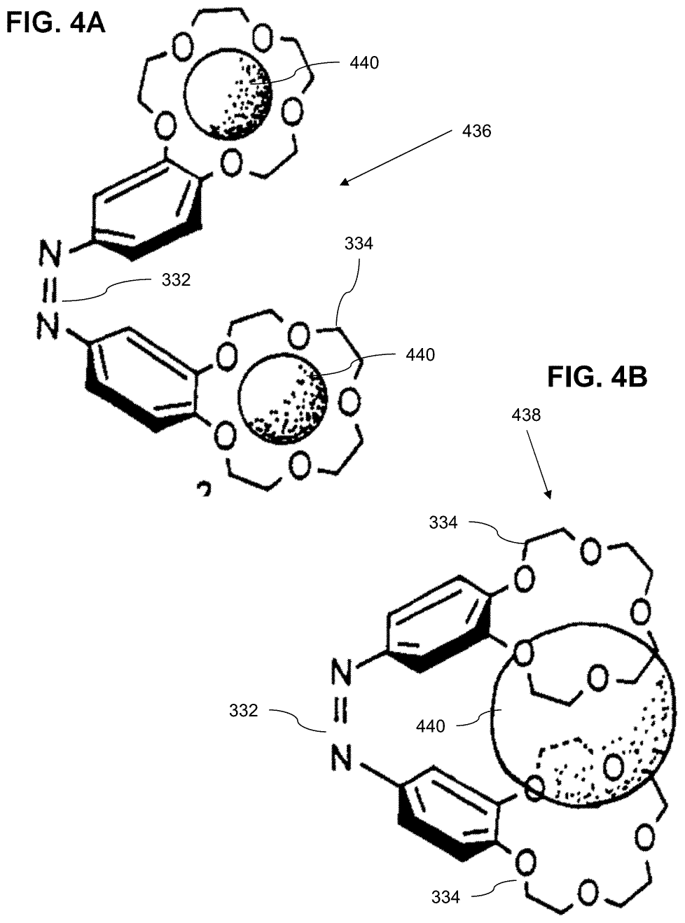

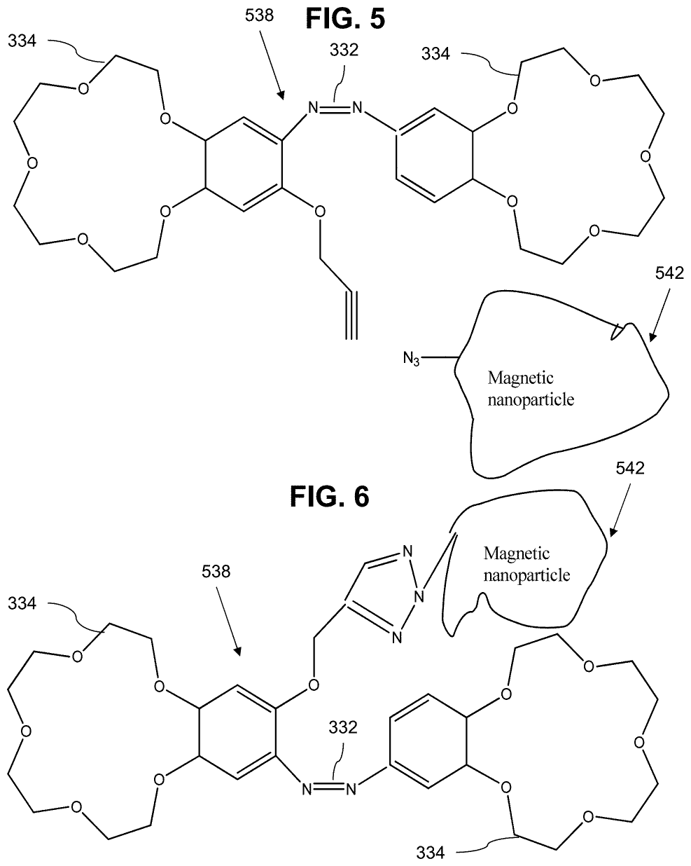

FIG. 5 is a schematic view of a complexing agent 538 with an Alkyne-modified Bis Benzocrown disattached from a magnetic nanoparticle in accordance with an embodiment of the current invention. FIG. 6 is a schematic view of an Alkyne-modified Bis Benzocrown attached at a condition of Alkyne-Azide Huisgen bipolar 1.3-cycloaddition to a magnetic nanoparticle in accordance with an embodiment of the current invention. The nanoparticles can range in diameter, between about 1 nm and about 500 nm, preferably 1 to 50 nm most preferably 1 to 20 nm. Optionally, a covalent bond between functionalized magnetic nanoparticles and functionalized crown Ether is formed via carboxyl to amine coupling from both sides. The resulting particle/nanoparticle is a magnetic active complexing unit in accordance with an embodiment of the current invention. Connection of the magnetic nanoparticle to the complexing agent may include a triazole,amide,ester, a substituted amide, various covalent bonds and many other connections.

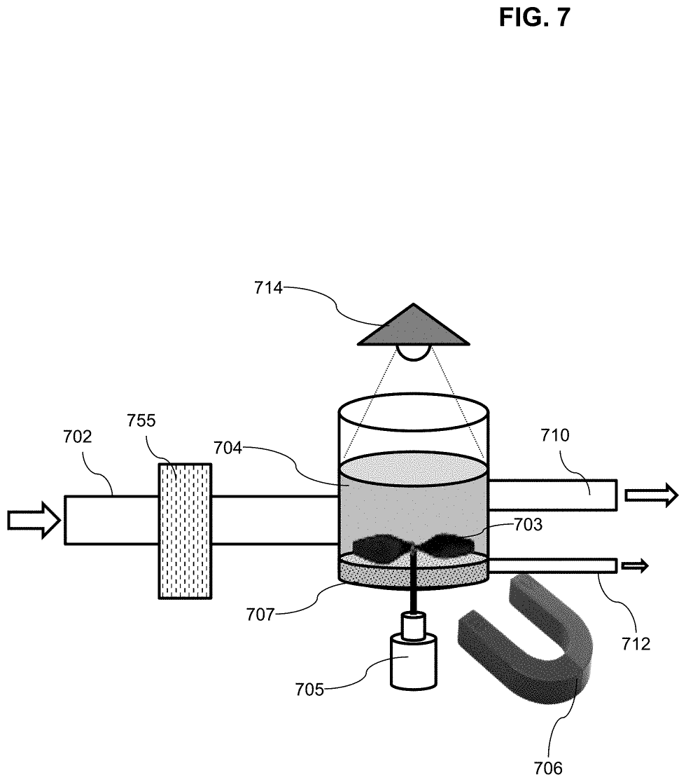

FIG. 7: is a schematic illustration of a scalable desalination system in accordance with an embodiment of the current invention. In some embodiments, the system includes an inlet 702 in fluid communication with a reactor 704. For example, the reactor 704 may include a tank stirred by an impeller 703 driven by a motor 705 for raw contaminated water (e.g. sea water). Optionally a pretreatment module 755 which may include for example a sand filter and/or a carbon filter and/or a porous filter and/or a mesh filter and/or a ceramic filter and/or a chemical treatment.

In some embodiments, the system includes a particle concentrator 706. Optionally, the concentrator is activated to collect the complexing particles and/or a contaminant complexed thereto to an impound area 707 (for example near the bottom of the reactor 704) which in the embodiment of FIG. 7 is also a release area. For example, the concentrator 706 may include a magnet. For example, the magnet may include an electromagnet that is activated and/or deactivated by switching on or off power to the magnet. Alternatively or additionally, the concentrator may include a permanent magnet (e.g. a rare earth magnet) which is activated/deactivated by moving the magnet near and/or away from the impound area 707. Alternatively or additionally, the magnet may remain active permanently and/or the contaminated water may be circulated through the impound area to react with the particles (for example by strong mixing with a mixing module [e.g. impeller 703]). Once the particles and/or contaminant are concentrated in the impound area, clean water may be drained off through a clean water outlet 710. Optionally, suitable sensors measure the salt level and/or a controller monitors the sensors for example, to verify that the water is clean. Optionally, the controller will control various actuators (e.g. pumps, valves and/or other components of the system to achieve desired water quality and/or desired water quantity and/or reduce costs and/or increase efficiency. For example, the clean water outlet 710 may drain fluid from the reactor 704 at an area separated (e.g. far away from and/or isolated by a barrier) from the impound area 707.

In some embodiments, a release module 714 causes the particles to release a portion of the contaminant complexed to them. For example, the release module 714 may include an energy source (e.g. a UV radiation source) that radiates energy to the particles and/or the impound area 707. Optionally, after the contaminant has been released, concentrated contaminant is drained via a waste outlet 712. For example, the waste outlet 712 may be in fluid communication with the impound area and/or drain fluid from the impound area. Draining fluid from the impound area is optionally performed while the particles are retained in the reactor 704, for example via the concentrator 706 retaining the particles. For example, the particles may be retained by a magnetic field and/or the particles may be retained in the impound area.

In some embodiments, the complexing particles are optionally added to the reactor continuously depending on the volume of water that needs to be treated and/or according to the desired quality (e.g. salinity) of the output water. After the reactor is filled with water, the mixer will mix while an exit valve is closed. Once the reaction has equilibrated, a magnetic field will optionally be applied, preferably using a permanent magnet at the bottom of the reactor with an open exit valve from water tank. The nanoparticles will be collected at the bottom of the water tank. The water flows to next step by gravitation or with low pressure pumps.

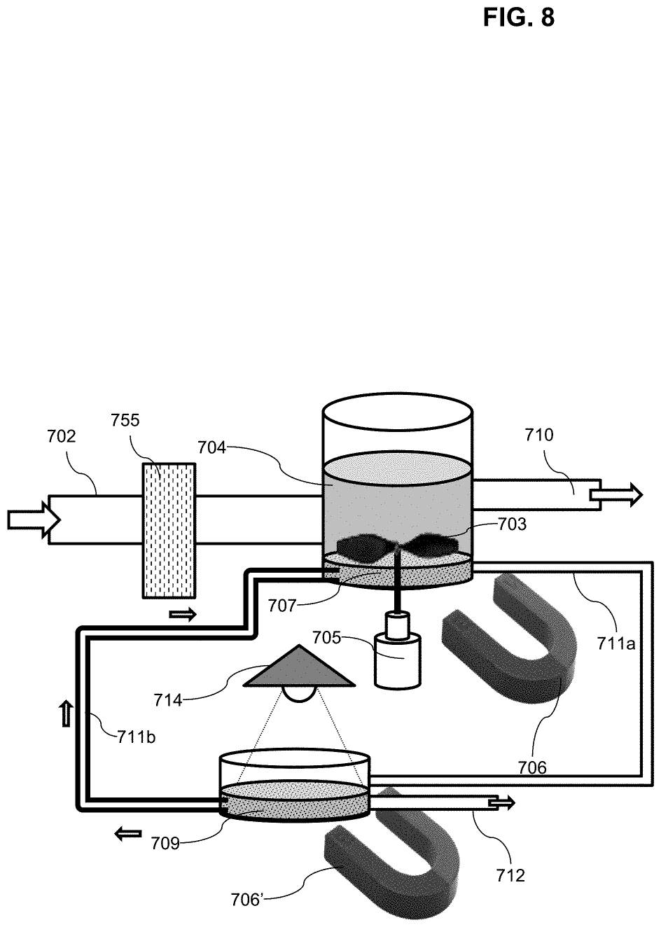

FIG. 8 is a schematic illustration of a scalable desalination system with active particle return in accordance with an embodiment of the current invention.

In some embodiments, a recirculation line 711a is in fluid communication with the impound area 707 and/or a release area 709. While, particles and/or complexed contaminant are concentrated in the impound area 707, clean water is removed from outlet 710. Optionally, some or all of the remaining fluid and/or the particles and/or the complexed contaminant are drained through the recirculation line 711a to a release area 709. In some embodiments, a release module 714 causes the particles to release a portion of the contaminant complexed to them. For example, the release module 714 may include an energy source (e.g. a UV radiation source) that radiates energy to the particles and/or the release area 709. Optionally, after the contaminant has been released, concentrated contaminant is drained via a waste outlet 712. For example, the waste outlet 712 may be in fluid communication with the impound area and/or drain fluid from the impound area. Draining fluid from the impound area is optionally performed while the particles are retained in the reactor 704, for example via a concentrator 706′ retraining the particles in the impound area (optionally concentrator 706′ may be the same as concentrator 706. For example, the impound area and/or the release area 709 may be close enough to each other to both be affected by (e.g. be within an effective portion of the magnetic field of) one concentrator 706. Alternatively, concentrator 706 may move between a position which retains particles in impound area 707 and a position which retains particles in the release area 709.

In some embodiments, the complexing particles are optionally added to the reactor continuously depending on the volume of water that needs to be treated. After the reactor is filled with water, the mixer will mix while an exit valve is closed. Once the reaction has equilibrated, a magnetic field will optionally be applied, preferably using a permanent magnet at the bottom of the reactor with an open exit valve from water tank. Optionally, while fluid is exiting the tank in return line 711a concentrator 706 is deactivated allowing the particles to flow to the release area 709. Optionally, when concentrated contaminant is drained through the waste outlet 712 while concentrator 706′ holds the particles in the release zone. Optionally, after release of the complexed particles a returned to the reactor, for example, via a recycle line 711b.

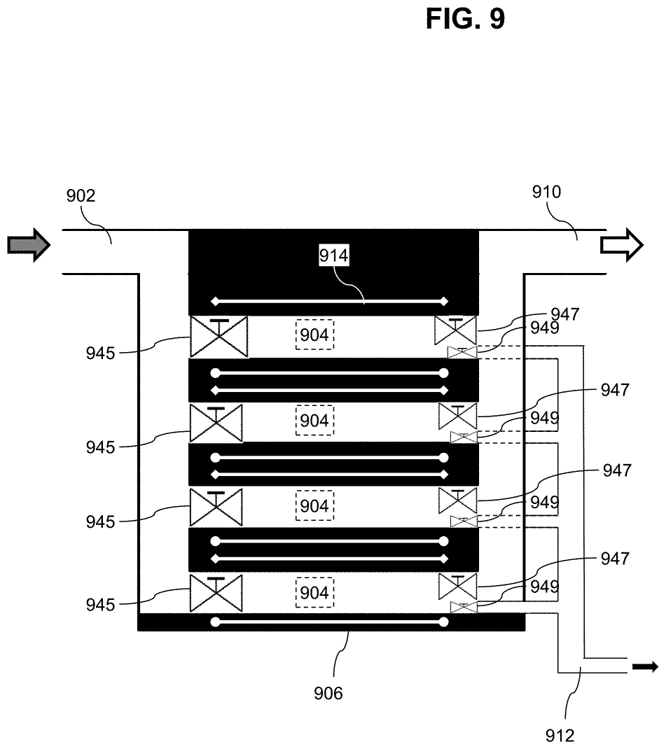

FIG. 9 is a schematic illustration of a scalable desalination system in accordance with an embodiment of the current invention. In some embodiments, contaminated fluid enters an inlet 902 and is directed through a series of valves 945 to a series of parallel reactors 904. Each reactor 904 including a concentrator 906 and/or a release module 914. For example, incoming contaminated fluid is mixed with complexing magnetic particles which complex the contaminant. The incoming fluid is channeled and divided through valves 945 to parallel reactors 904 where the particles and the complexed contaminant are collected by the concentrators into in impound area of the reactors 904. Clean water is discharged from each reactor through an outlet valve 947 (optionally in communication with the reactor 904 but isolated from the impound area) to an outlet 910. Optionally, after discharging the clean water, a series of waste release valve 949 are opened connecting each impound zone to a waste outlet manifold 912 and/or discharging concentrated contaminant. Optionally during discharge, the concentrator remains active, holding the particles in the reactor for the next batch of water. In some embodiments, the clean water is outlet from the system for use. Alternatively or additionally, the clean outlet water may be recirculated to the inlet 902 for further purification.

Details of the concentrators 906, release modules 914 and/or particles may be similar to other embodiments described herein.

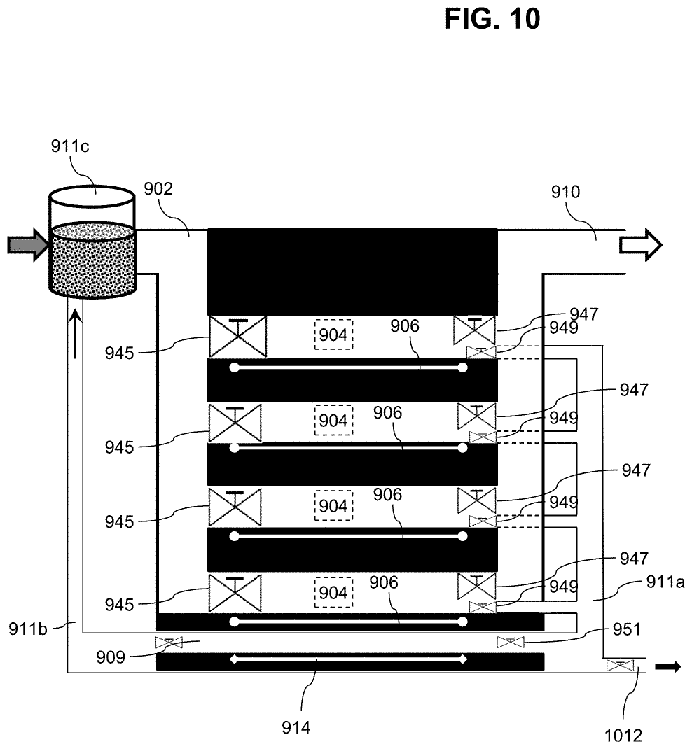

FIG. 10 is a schematic illustration of a scalable desalination system with active particle return in accordance with an embodiment of the current invention. In some embodiments, instead of releasing contaminant from the complexing particles in the series of reactors 904, the particles with the complexed contaminant are channeled by valves 949 to a recirculation channel 911a to a release area 909 wherein a release module 914 releases the contaminant. Optionally while the particles are held in the release area by a concentrator 906, the concentrated waste is released through a waster outlet valve 951 to the outlet 1012. Optionally the particles are then recycled to the incoming fluid through a recycling line 911b and/or a mixing tank 911c and/or back to the reactors 904.

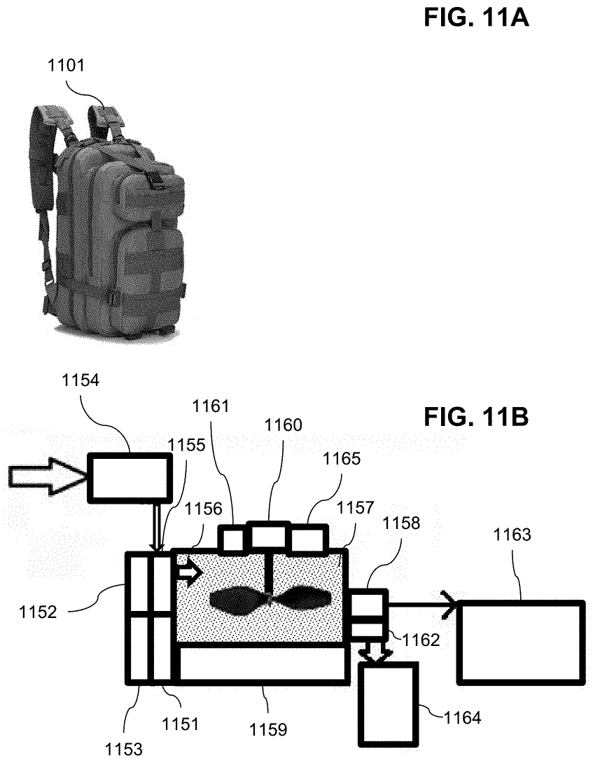

FIG. 11A is an image of a backpack water purification system in accordance with an embodiment of the current invention. FIG. 11B is schematic illustration of a backpack water purification system in accordance with an embodiment of the current invention.

In some embodiments, a small desalination system may fit into a backpack 1101 and/or be light enough to be carried by a person. For example, the system may weigh between 5 to 20 kg and/or between 1 to 5 kg and/or between 20 to 40 kg. For example, the total volume of the system may range between 30 to 50 liters.

In some embodiments, the system may include a power supply unit PSU 1151. Optionally the PSU 1151 includes a power DC to DC converter module. This unit optionally further includes a rechargeable battery 1153 (and/or another portable power supply which is optionally located inside the backpack). For example, the power converter may split the power giving respective levels of voltage and/or current to each of the other system modules. In some embodiments, the system may not include battery 1153 and/or may be configured to use power from an external power supply (e.g. an external battery, a generator, a solar power source and/or a domestic power grid). Optionally, a solar converter may be included and/or may be used to recharge battery 1153.

In some embodiments, a Command and Control Unit CCU 1152 performs command & control. For example, the CCU 1152 may include a processor that controls various other modules and/or the CCU 1152 may include sensors for example for verifying that system modules are working properly. The CCU 1152 may output information for example on a locally screen or smart phone, for example via RF communication like Wi-Fi/Bluetooth.

In some embodiments, an inlet module 1154 includes for example a tube that connects the system to a contaminated water source (e.g. sea water contaminated with salt). Alternatively or additionally, the inlet includes a water pump. Optionally the pump is operationally connected to PSU 1151 to get the power and/or to CCU 1152 for control.

In some embodiments, the system includes a pretreatment module 1155. For example, the pretreatment modules 1155 may include a filter (for example a sand filter and/or a carbon filter and/or a porous filter and/or a mesh filter and/or a ceramic filter).

In some embodiments, a system may include a water valve 1156 in order to control the input water. For example, valve 1156 may be located between pretreatment module 1155 and a main reactor. For example, the main reactor may include a tank 1157 and/or a mixing unit 1160. Optionally valve 1156 is operationally connected to PSU 1151 to get the power and/or to CCU 1152 for control.

In some embodiments, the system includes an output valve 1158 that controls water movement from the main reactor to a fresh water tank 1163. Optionally valve 1158 is operationally connected to PSU 1151 to get the power and/or to CCU 1152 for control.

In some embodiments, a system includes an Electro Magnet 1159. Optionally magnet 1159 is operationally connected to PSU 1151 to get the power and/or to CCU 1152 for control.

In some embodiments, the system includes a mixing unit 1160. For example, mixing unit may include a motor connected to a suitable water propeller which causes circulation inside the main reactor 1157. Optionally mixing unit 1160 is operationally connected to PSU 1151 to get the power and/or to CCU 1152 for control.

In some embodiments a system includes an energy source 1161, for example a UV light. Optionally energy source 1161 is operationally connected to PSU 1151 to get the power and/or to CCU 1152 for control.

In some embodiments, reactor 1157 is filled with contaminated water and/or mixed with active particles which complex with the contaminant (e.g. salt). Optionally, the contaminant and/or the particles are then separated from the water, for example, by activating magnet 1159 to draw the particles with the contaminant to the bottom of the reactor 1157. Optionally clean water can then be drained from a higher portion of the reactor 1157 (e.g. using output valve 1158). The clean water may be output and/or returned to the reactor for further purification. Optionally, energy source 1161 is activated after the fresh water has been drained from the reactor 1157. For example, the bottom of the main reactor 1157 contains the particles which hold the contaminant. At this stage the UV light optionally directs light to the nanoparticles causing them to release contaminant. After this stage the remaining concentrated contaminated water is optionally moved out via gravitation and/or a pump 1162 and/or valve while magnet 1159 continues to hold the particles.

In some embodiments after contaminant release from the particles, waste (for example concentrated contaminant with some water) is directed to a waste outlet 1164. For example, waste outlet 1164 may include a waste tank and/or a tube back to the contaminated water source and/or to an external dumping ground (e.g. an output tube that drains to the ground and/or a domestic drain).

In some embodiments, a system may include sensors 1165. For example, sensors 1165 may measure the volume and/or quality of water in reactor 1157 and/or fresh water tank 1163 and/or waste tank 1164. For example, sensors may measure flow between components and/or power consumption and/or battery 1153 status and/or temperature of various components. Optionally sensors 1165 are operationally connected to PSU 1151 to get the power and/or to CCU 1152 for control and/or to report data.

In some embodiments, a backpack desalination system may produce between 1 to 10 liters and/or between 10 to 50 liters and/or between 50 to 200 liters per day. For example, a bigger heavier pack may produce more water. Optionally, the backpack may include storage of clean water, for example between 1 to 4 liters and/or between 4 to 15 liters. Optionally, a backpack may include a rechargeable battery. For example, the battery may include power for between 1 hour to 12 hours and/or between 12 hours to 48 hours and/or between 48 hours to 200 hours of operation. Alternatively or additionally, the backpack may include a one or more mirrors and/or lenses to direct sunlight as a source of light for salt release, for example, when UV light source is not available

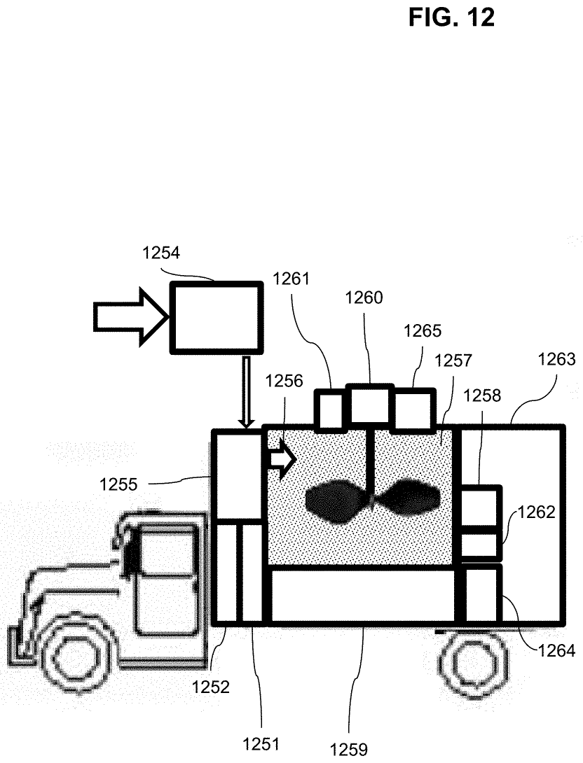

FIG. 12 is schematic illustration of a vehicle transportable water purification system in accordance with an embodiment of the current invention. For example, the transportable system may be connected to a dedicated vehicle (e.g. an SUV and/or a small truck and/or a large truck and/or a train car) and/or a transportable package (e.g. a system on a pallet for easy transport in trucks and/or by air and/or a standard cargo container for easy transport by air, sea and/or truck and/or rail).

In some embodiments, the system may include a power supply unit PSU 1251. Optionally the PSU 1251 includes a power DC to DC converter module. This unit optionally connects to a power supply of the vehicle. For example, the power converter may split the power giving respective levels of voltage and/or current to each of the other system modules. In some embodiments, the system may be configured to use power from an external power supply (e.g. an external battery, a generator, a solar power source and/or a domestic power grid).

In some embodiments, a Command and Control Unit CCU 1252 performs command & control. For example, the CCU 1252 may include a processor that controls various other modules and/or the CCU 1252 may include sensors for example for verifying that system modules are working properly. The CCU 1252 may output information for example on a locally screen or smart phone, for example via RF communication like Wi-Fi/Bluetooth.

In some embodiments, an inlet module 1254 includes for example a tube that connects the system to a contaminated water source (e.g. sea water contaminated with salt). Alternatively or additionally, the inlet includes a water pump. Optionally the pump is operationally connected to PSU 1251 to get the power and/or to CCU 1252 for control.

In some embodiments, the system includes a pretreatment module 1255. For example, the pretreatment modules 1255 may include a filter (for example a sand filter and/or a carbon filter and/or a porous filter and/or a mesh filter and/or a ceramic filter.

In some embodiments, a system may include a water valve 1256 in order to control the input water. For example, valve 1256 may be located between pretreatment module 1255 and a main reactor. For example, the main reactor may include a tank 1257 and/or a mixing unit 1260. Optionally valve 1256 is operationally connected to PSU 1251 to get the power and/or to CCU 1252 for control.

In some embodiments, the system includes an output valve 1258 that controls water movement from the main reactor to a fresh water tank 1263. Optionally valve 1258 is operationally connected to PSU 1251 to get the power and/or to CCU 1252 for control.

In some embodiments, a system includes an Electro Magnet 1259. Optionally magnet 1259 is operationally connected to PSU 1251 to get the power and/or to CCU 1252 for control.

In some embodiments, the system includes a mixing unit 1260. For example, mixing unit may include a motor connected to a suitable water propeller which causes circulation inside the main reactor 1257. Optionally mixing unit 1260 is operationally connected to PSU 1251 to get the power and/or to CCU 1252 for control.

In some embodiments a system includes an energy source 1261, for example a UV light. Optionally energy source 1261 is operationally connected to PSU 1251 to get the power and/or to CCU 1252 for control.

In some embodiments, reactor 1257 is filled with contaminated water and/or mixed with active particles which complex with the contaminant (e.g. salt). Optionally, the contaminant and/or the particles are then separated from the water, for example, by activating magnet 1259 to draw the particles with the contaminant to the bottom of the reactor 1257. Optionally clean water can then be drained from a higher portion of the reactor 1257 (e.g. using output valve 1258). The clean water may be output and/or returned to the reactor for further purification. Optionally, energy source 1261 (for example including a light source and/or a UV light source) is activated after the fresh water has been drained from the reactor 1257. For example, the bottom of the main reactor 1257 contains the particles which hold the contaminant. At this stage the UV light optionally directs light to the nanoparticles causing them to release the contaminant. After this stage the remaining concentrated contaminated water is optionally moved out to waste outlet 1264 via gravitation and/or a pump 1262 and/or valve while magnet 1259 continues to hold the particles. In some embodiments after contaminant release from the particles, waste (for example concentrated contaminant with some water) is directed to a waste outlet 1264. For example, waste outlet 1264 may include a waste tank and/or a tube back to the contaminated water source and/or to an external dumping ground (e.g. an output tube that drains to the ground and/or a domestic drain).

In some embodiments, a system may include sensors 1265. For example, sensors 1265 may measure the volume and/or quality of water in reactor 1257 and/or fresh water tank 1263 and/or waste tank 1264. For example, sensors may measure flow between components and/or power consumption and/or temperature of various components. Optionally sensors 1265 are operationally connected to PSU 1251 to get the power and/or to CCU 1252 for control and/or to report data.

In some embodiments, a system mounted on a car and/or a SUV and/or a van and/or a light truck and/or a truck may produce between 100 to 1,000 liters and/or between 1,000 to 10,000 liters and/or between 10,000 to 100,000 liters of water per day. For example, the car and/or SUV and/or van and/or light truck may store clean water in a quantity of between 100 to 1000 liters and/or between 1000 to 10000 liters. For example, the truck may store clean water in a quantity of between 100 to 10,000 liters and/or between 10,000 to 80,000 liters.

In some embodiments, the car and/or SUV and/or van and/or light truck and/or truck includes a rechargeable battery which may support operation of the water purifying system for between 1 hour to 1 day and/or between one day to 1 week.

In some embodiments, the car and/or SUV and/or van and/or light truck and/or truck includes fuel and/or an alternator which may support operation of the water purifying system for between 1 hour to 1 day and/or between one day to 1 week and/or between 1 week to 1 month and/or between 1 month to 1 year. For example, the car and/or SUV and/or van and/or light truck and/or truck may be configured to purify between 1 to 40 and/or between 40 to 200 and/or between 200 to 1000 liters per hour and/or between 1,000 to 10,000 liters per hour. For example, the car and/or SUV and/or van and/or light truck and/or truck may be configured to store between 1 to 40 and/or between 40 to 200 and/or between 200 to 1000 and/or 1000 to 10,000 and/or 10,000 to 80,000 liters of clean water.

In some embodiments, a suitable truck mounted purification system and/or a container mounted system may produce between 100 to 1000 liters and/or between 1000 to 10,000 liters and/or between 10,000 to 100,000 gallons of water per day. In some embodiments, the suitable truck mounted purification system and/or container mounted system may store between 100 to 1000 liters and/or between 1000 to 10,000 liters and/or between 10,000 to 100,000 liters of water. In some embodiments, the suitable truck mounted purification system and/or container mounted system includes a rechargeable battery which may support operation of the water purifying system for between 1 hour to 1 day and/or between one day to 1 week. In some embodiments, the suitable truck mounted purification system and/or container mounted system includes fuel and/or an alternator and/or generator which may support operation of the water purifying system for between 1 hour to 1 day and/or between one day to 1 week and/or between 1 week to 1 month and/or between 1 month to 1 year. For example, the suitable truck mounted purification system and/or container mounted system may be configured to purify between 10 to 400 and/or between 400 to 2000 and/or between 2000 to 50,000 liters per hour.

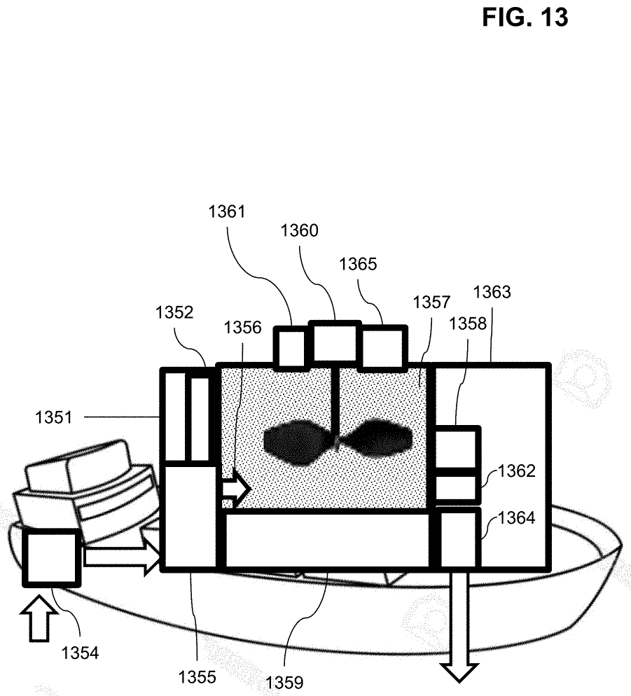

FIG. 13 is schematic illustration of a ship transportable water purification system in accordance with an embodiment of the current invention.

In some embodiments, the system may include a power supply unit PSU 1351. Optionally the PSU 1351 includes a power DC to DC converter module. This unit optionally connects to a power supply of the ship. For example, the power converter may split the power giving respective levels of voltage and/or current to each of the other system modules. In some embodiments, the system may be configured to use power from an external power supply (e.g. an external battery, a generator, a solar power source).

In some embodiments, a Command and Control Unit CCU 1352 performs command & control. For example, the CCU 1352 may include a processor that controls various other modules and/or the CCU 1352 may include sensors for example for verifying that system modules are working properly. The CCU 1352 may output information for example on a locally screen or smart phone, for example via RF communication like Wi-Fi/Bluetooth.

In some embodiments, an inlet module 1354 includes for example a tube that connects the system to a contaminated water source (e.g. sea water contaminated with salt). Alternatively or additionally, the inlet includes a water pump. Optionally the pump is operationally connected to PSU 1351 to get the power and/or to CCU 1352 for control.

In some embodiments, the system includes a pretreatment module 1355. For example, the pretreatment modules 1355 may include a filter (for example a sand filter and/or a carbon filter and/or a porous filter and/or a mesh filter and/or a ceramic filter.

In some embodiments, a system may include a water valve 1356 in order to control the input water. For example, valve 1356 may be located between pretreatment module 1355 and a main reactor. For example, the main reactor may include a tank 1357 and/or a mixing unit 1360. Optionally valve 1356 is operationally connected to PSU 1351 to get the power and/or to CCU 1352 for control.

In some embodiments, the system includes an output valve 1358 that controls water movement from the main reactor to a fresh water tank 1363. Optionally valve 1358 is operationally connected to PSU 1351 to get the power and/or to CCU 1352 for control.

In some embodiments, a system includes an Electro Magnet 1359. Optionally magnet 1359 is operationally connected to PSU 1351 to get the power and/or to CCU 1352 for control.

In some embodiments, the system includes a mixing unit 1360. For example, mixing unit may include a motor connected to a suitable water propeller which causes circulation inside the main reactor 1357. Optionally mixing unit 1360 is operationally connected to PSU 1351 to get the power and/or to CCU 1352 for control.

In some embodiments a system includes an energy source 1361 (e.g. a source of light and/or UV light). Optionally energy source 1361 is operationally connected to PSU 1351 to get the power and/or to CCU 1352 for control.

In some embodiments, reactor 1357 is filled with contaminated water and/or mixed with active particles which complex with the contaminant (e.g. salt). Optionally, the contaminant and/or the particles are then separated from the water, for example, by activating magnet 1359 to draw the particles with the contaminant to the bottom of the reactor 1357. Optionally clean water can then be drained from a higher portion of the reactor 1357 (e.g. using output valve 1358). The clean water may be output and/or returned to the reactor for further purification. Optionally, energy source 1361 is activated after the fresh water has been drained from the reactor 1357. For example, the bottom of the main reactor 1357 contains the particles which hold the contaminant. At this stage the UV light optionally directs light to the nanoparticles causing them to release the contaminant. After this stage the remaining concentrated contaminated water is optionally moved out, for example, to waste outlet 1364, via gravitation and/or a pump 1362 and/or valve while magnet 1359 continues to hold the particles.

In some embodiments after contaminant release from the particles, waste (for example concentrated contaminant with some water) is directed to a waste outlet 1364. For example, waste outlet 1364 may include a waste tank and/or a tube back to the contaminated water source and/or to an external dumping ground (e.g. an output tube that drains to the ground and/or a domestic drain).

In some embodiments, a system may include sensors 1365. For example, sensors 1365 may measure the volume and/or quality of water in reactor 1357 and/or fresh water tank 1363 and/or waste tank 1364. For example, sensors may measure flow between components and/or power consumption and/or temperature of various components. Optionally sensors 1365 are operationally connected to PSU 1351 to get the power and/or to CCU 1352 for control and/or to report data.

It is expected that during the life of a patent maturing from this application many relevant technologies will be developed and the scope of the terms are intended to include all such new technologies a priori.

As used herein the term “about” refers to ±10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. When multiple ranges are listed for a single variable, a combination of the ranges is also included (for example the ranges from 1 to 2 and/or from 2 to 4 also includes the combined range from 1 to 4).

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non limiting fashion.

Desalination with diazobiscrown-ether functionalized nanoparticles was performed when functionalized nanoparticles were added to distilled water with known amount of NaCl and steered for several hours. The sample was then steered and filtered to separate the nanoparticles from the water. The presence and quantification of remaining NaCl was tested by titration using the Mohr method. Results are summarized in table 1.

The nanoparticles were then added to a double distilled water and the mixture was exposed to UV light UV light (400 nm wave length) for 20 min, using SCHOTT KL1500 Electronic 150 watt halogen lamp with optic fiber and a UV filter to receive 400 nm wave length, and then filtered and the filtered water was titrated for detection and quantification of NaCl. It was found that around half of the NaCl, was release into the water upon UV radiation. Results are summarized in table 1. A second capture test with the used nanoparticles on a new salt solution, showed that the expected amount of NaCl for reused nanoparticles was captured and again after UV exposure the same amount was released, validating that the functionalized nanoparticles work as expected. Titration of chloride was done by Mohr method using 1 mL of 5% potassium chromate solution as indicator.

Before every titration the method was tested and calibrated on a sample of water with a known amount of NaCl.

TABLE 1
Summary of the functionalized nanoparticles
activity upon capture and
released of sodium ions.

| nanoparticles | 1^{st} catch | 1^{st} release | 2^{nd} catch | 2^{nd} release |
|---|---|---|---|---|
| 3.24 g | 0.435 | 0.245 | 0.154 | 0.154 |
| 2.257 g | 0.3 | 0.144 | 0.148 | 0.14 |

The two batches of nanoparticles were combined and about 5 g of nanoparticles captured 0.24 mmol of NaCl and released 0.205 mmol.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A system for purifying water comprising:
complexing units including each of said complexing units including a complexing site configured to bind a contaminant a reactor configured for mixing water containing said contaminant with said complexing units a concentrator configured for drawing said complexing units to a release area said release area selected from inside of said reactor and in communication with said reactor;
an energy source configured to direct energy to said release area causing said complexing sites release a portion of said contaminant.

2. The system of claim 1, wherein said concentrator includes a magnet.

3. The system of claim 2, wherein said magnet is movable between a location near said release site for concentrating said particles and a location far from said release site for freeing said particles.

4. The system of claim 1, wherein said energy source is configured to direct light to said release area.

5. The system of claim 1, wherein said energy source includes at least one of a source of ultra violet light and a means to direct sunlight to said release area.

6. The system of claim 1, wherein said contaminant is salt and said complexing site is configured to bind a component of said salt.

7. A complexing unit for use in purifying water comprising:
at least two complexing sites a joint connecting said at least two complexing sites, said joint having a release mode and a collecting mode wherein said in said collecting mode, said at least two complexing sites are far apart and can each complex a contaminant ion and in said release mode said at least two complexing sites are close together such that repulsion between like ions prevents at least a portion of said complexing sites from complexing said contaminant.

8. The complexing unit of claim 7, wherein each said at least two complexing sites includes a crown ether.

9. The complexing unit of claim 7, wherein said joint includes a diazo moiety.

10. The complexing unit of claim 7, further comprising:
a magnetic portion for magnetic filtering of the complexing unit.

11. The complexing unit of claim 7, wherein said contaminant includes salt.

12. The complexing unit of claim 7, wherein said joint is configured to change said mode by exposure to an energy.

13. The complexing unit of claim 12, wherein said energy includes light.

14. The complexing unit of claim 12, wherein said energy includes sunlight.

15. A method of water purification comprising:
mixing a plurality of complexing units with water containing a contaminant;
binding said contaminant with said complexing units;
concentrating said complexing units bound to said contaminant to a impound area;
outputting clean water from a portion of said reactor isolated from said impound zone;
releasing said contaminant from said complexing units into a reduced water volume thereby producing concentrated contaminant;
collecting said concentrated contaminant.

16. The method of claim 15, wherein said releasing includes exposing said complexing units to radiation.

17. The method of claim 15, wherein said concentrating includes exposing said complexing units to a magnetic field.

18. The method of claim 15, wherein said contaminant includes salt.

19. The method of claim 15, wherein said complexing agent includes a crown ether.

20. The method of claim 15, wherein said complexing unit includes a joint connecting said at least two complexing units, said joint having a release mode and a collecting mode wherein said in said collecting mode, said at least two complexing units are far apart and can each complex a contaminant ion and in said release mode said at least two complexing units are close together such that repulsion between like ions prevents at least a portion of said complexing units from complexing said contaminant.
